(19) United States
(12) Patent Application Publication
(10) Pub. No.: US 2011/0246693 A1
(43) Pub. Date: Oct. 6, 2011

(54) System For Synchronizing Hierarchically Combined Motion Control

(76) Inventors: Se Jin KANG, Seoul (KR); Kwan Ok KIM, Seoul (KR)

(21) Appl. No.: 12/762,393

(22) Filed: Apr. 19, 2010

(30) Foreign Application Priority Data
Apr. 2, 2010 (KR) 10-2010-0030554

(51) Int. Cl. G06F 13/40; G06F 13/36

(52) U.S. Cl. 710/110; 710/113

(57) ABSTRACT

There is provided a system for synchronizing hierarchically combined motion control, whereby small-scale, large-scale and remote control networks are controlled by a single control system, using a bus arbiter.

The system comprises: an upper control block, a plurality of lower control blocks, a plurality of remote control blocks, and a plurality of bus arbiters to sequentially assign a bus use bandwidth to each of the lower control blocks, the bus arbiters positioned between the upper control block and each of the lower control blocks and between the upper control block and each of the remote control blocks.

### CROSS-REFERENCE TO RELATED APPLICATION

This application claims the benefit of Korean Patent Application No. 2010-0030554, filed Apr. 2, 2010, the disclosure of which is hereby incorporated herein by reference in its entirety.

### BACKGROUND OF THE INVENTION

1. Field of the Invention

The present invention relates to a system for synchronizing hierarchically combined motion control, and more particularly, to a system for synchronizing hierarchically combined motion control, whereby small-scale, large-scale and remote control networks are controlled by a single control system, using a bus arbiter.

2. Description of the Related Art

As small-size and low-cost systems have been developed, the technology has been expanded to control a plurality of function modules at the same time or to integrate a plurality of function modules into a single chip.

In general, a plurality of function modules accesses a main memory of a system, thereby processing data. Then, the system includes a bus to connect a plurality of function modules and a bus arbiter to efficiently perform bus arbitration.

For data processing, function modules are assigned with buses and access memory. When the number of function modules requesting access to a memory is more than one, a bus is assigned to any one of the function modules, to prevent a bus crash.

Conventional bus arbitration methods to prevent a bus crash use a fixed scheme, a priority scheme, and a bus bandwidth limiting priority scheme.

The fixed scheme is to equally distribute use of a bus to each function module which requests access to a memory. The order of distributing the use of a bus is randomly determined and it is impossible to change the order during a system operates. Therefore, no bus starvation occurs in the fixed scheme. However, when data need to be urgently processed, processing the data is delayed because it follows the order.

The priority scheme is to give a priority to each function module by confirming the importance and urgency of the each function module and to process data based on the priority. According to this scheme, urgent data are promptly processed. However, when a function module has a large amount of data to be processed, another function module has to wait for a long time to process data.

The bus bandwidth limiting priority scheme is to limit a bus bandwidth to be assigned to each function module given with a priority. This scheme solves the problem of the priority scheme. However, when a function module with a high priority is requested to process a large amount of data, even though the function module has the high priority by the bandwidth limitation, it takes a longer time for the function module to process the data, compared to a processing time of another function module.

### SUMMARY OF THE INVENTION

Therefore, it is an object of the present invention to provide a system for synchronizing hierarchically combined motion control, whereby a small-scale control network, a large-scale control network and a remote control network are stably controlled in a single integrated control system.

In accordance with an embodiment of the present invention, there is provided a system for synchronizing hierarchically combined motion control, the system comprising: an upper control block; a plurality of remote control blocks; a plurality of lower control blocks; and a plurality of bus arbiters to sequentially assign a bus use bandwidth to each of the lower control blocks, the bus arbiters positioned between the upper control block and each of the lower control blocks and between the upper control block and each of the remote control blocks.

Each of the upper and lower control blocks comprises: a master controller to control respective control modules with respect to all the control blocks; a plurality of control modules to perform a function of actual motion control within the control blocks; and a plurality of control buses to send/receive control signals within the control blocks, wherein the control module may connected multi-level manner.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a block diagram illustrating hierarchical control in a system for synchronizing hierarchically combined motion control according to the present invention;

FIG. 2 is a block diagram illustrating subordinate control in the system;

FIG. 3 illustrates a structure of each control module in the system; and

FIG. 4 illustrates a structure of a bus arbiter in the system.

### DETAILED DESCRIPTION OF THE PREFERRED EMBODIMENT

The present invention will now be described more fully hereinafter with reference to the accompanying drawings, in which preferred embodiments of the invention are shown so that those of ordinary skill in the art can easily carry out the present invention.

A system for synchronizing hierarchically combined motion control according to the present invention comprises: an upper control block; a plurality of remote control blocks; a plurality of lower control blocks; and a plurality of bus arbiters to sequentially assign a bus use bandwidth to each of the lower control blocks, the bus arbiters positioned between the upper control block and each of the lower control blocks and between the upper control block and each of the remote control blocks.

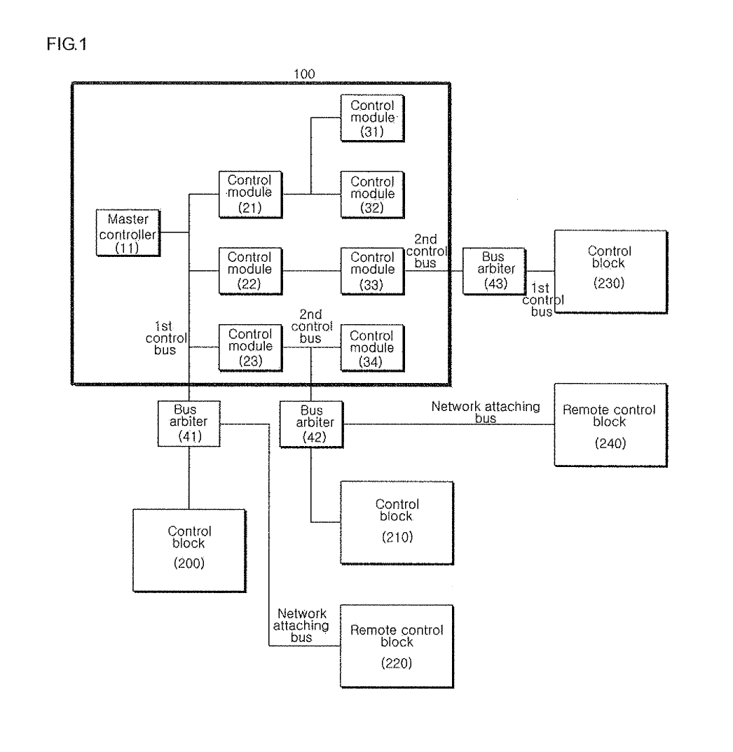

FIG. 1 is a block diagram illustrating hierarchical control in a system for synchronizing hierarchically combined motion control according to the present invention.

The system for synchronizing hierarchically combined motion control comprises: an upper control block 100, a plurality of remote control blocks 220 and 240, a plurality of lower control blocks 200, 210 and 230, and a plurality of bus arbiters 41, 42 and 43 to sequentially assign a bus use bandwidth to each of the lower control blocks 200, 210 and 230. Each of the bust arbiters 41, 42 and 43 are positioned between the upper control block 100 and each of the lower control blocks 200, 210 and 230.

Each of the upper control block 100 and lower control blocks 200, 210 and 230 comprises: a master controller 11 to control all the control blocks, a control bus to send/receive a control signal within each of the control blocks, and a number of control modules 21, 22, 23, 31, 32, 33 and 34 to control an actual motion in the control blocks. That is, the upper control block 100 and the lower control blocks 200, 210 and 230 may have the same structure, and the lower control blocks 200, 210 and 230 may be connected to other lower control blocks by other bus arbiters.

The upper control block 100 includes a number of the control modules 21, 22, 23, 31, 32, 33 and 34. As illustrated in FIG. 1, the control modules 31 and 32 are connected to and below the control module 21 in a parallel manner. However, FIG. 1 illustrates an example only. The control modules connected to and below the control module 21 may be structured in a serial manner and in a multi-level manner, or a number of control modules may be connected to the control module 21 in a parallel manner.

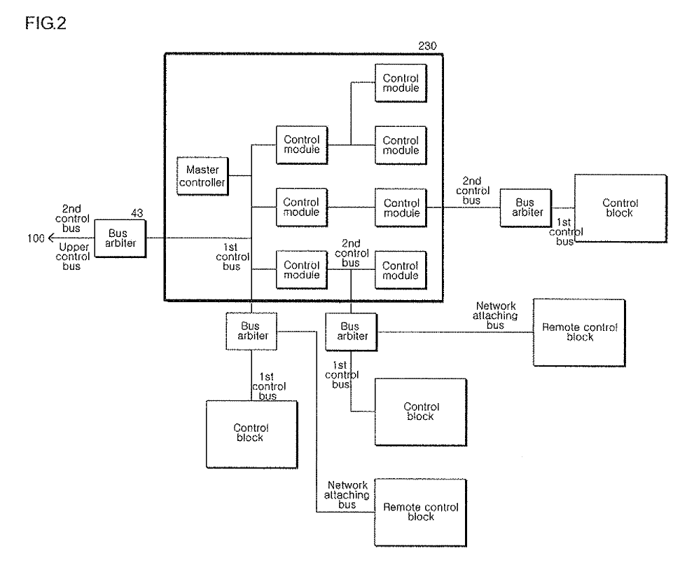

FIG. 2 is a block diagram illustrating subordinate control in the system. As illustrated in FIG. 1 and FIG. 2, the upper control block 100 and the lower control blocks 200, 210 and 230 according to the present invention have the same structure.

The bus arbiters 41, 42 and 43 perform arbitration of use of a bus among the control modules 21, 22, 23, 31, 32, 33 and 34, control blocks 200, 210, 230 and remote control blocks 220 and 240.

Each of the bus arbiters 41, 42 and 43 is positioned between the upper control block 100 and each of the lower control blocks 200, 210 and 230. As illustrated in FIG. 1, one end of each of the bus arbiters 41, 42 and 43 may be connected to the master controller 11 and the control modules (1^{st} control module, 2^{nd} control module, . . . n^{th} control module) of the upper control block 100, and the other end thereof may be connected to each of the lower control blocks 200, 210 and 230 or each of the remote control blocks 220 and 240.

As illustrated in FIGS. 1 and 2, when the master controller 11 and the control modules 21, 22 and 23 are connected to each other by a first control bus and when the other control modules (2^{nd} control modules) 31, 32, 33 and 34 are connected to and below the 1^{st} control modules 21, 22 and 23, the connection between these control modules is performed by a second control bus.

When the master controller 11 of the upper control block 100 is connected to lower control block 200 by the bus arbiter 41, the master controller 11 and the bus arbiter 41 are connected to each other by the first control bus, and further lower control block 200 may be connected to the bus arbiter 41 by the first control bus.

Each of the control modules 31, 32, 33 and 34 of the upper control block 100 is connected to the bus arbiter 43 by a second control bus, and the bus arbiter 43 is connected to the master controller 11 of the lower control block 230 by the first control bus.

The first control bus includes global or designated target control module addresses, control commands, and control data or status signals. Further, the first control bus may be formed of a frame or packet.

The second control bus includes designated target control module addresses, control commands, and control data or status signals. Further, the first control bus may be formed of a frame or packet.

A network attaching control bus uses the first or second control bus by summarizing or dissembling it as a packet.

Further, when the remote control block 220 is connected to the bus arbiter 41, they may be connected by the network attaching control bus.

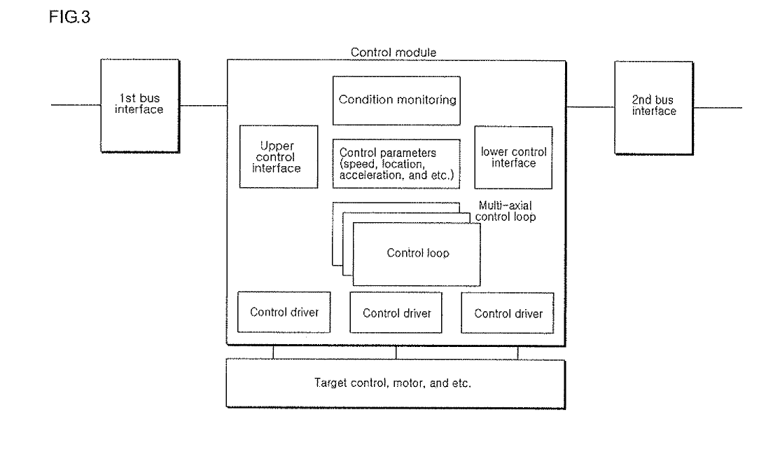

FIG. 3 illustrates the structure of each of the control modules in the system.

Each of the control modules comprises: a condition monitoring unit, a control parameter unit to store parameters, such as speed, location, acceleration, a control loop unit, a control driver unit, an upper control interface unit, and a lower control interface unit.

The condition monitoring unit monitors bus condition information. The upper control interface unit processes the interface with the upper control block. The lower control interface unit processes the interface with the lower control blocks.

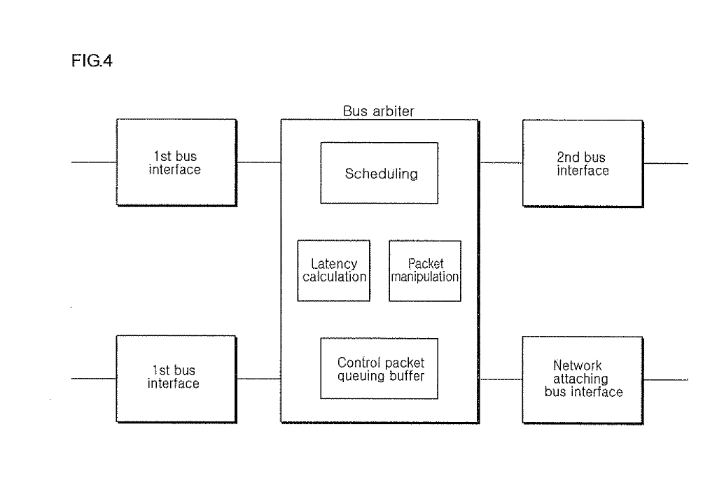

FIG. 4 illustrates the structure of the bus arbiter in the system.

Each of the bus arbiters comprises: a scheduling unit, a latency calculation unit, a packet manipulation unit, and a control packet queuing buffer unit.

As described above, the system for synchronizing hierarchically combined motion control according to the present invention is capable of stably controlling a small-scale control network, a large-scale control network and a remote control network in the single integrated control system.

The invention has been described using preferred exemplary embodiments. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

What is claimed is:

1. A system for synchronizing hierarchically combined motion control, comprising:
an upper control block,
a plurality of lower control blocks,
a plurality of remote control blocks, and
a plurality of bus arbiters to sequentially assign a bus use bandwidth to each of the lower control blocks, the bus arbiters positioned between the upper control block and each of the lower control blocks and between the upper control block and each of the remote control blocks.

2. The system according to claim 1, wherein each of the upper and lower control blocks comprises:
is a master controller to control respective control modules with respect to all the control blocks,
a plurality of control modules to perform a function of actual motion control within the control blocks, and
a plurality of control buses to send/receive control signals within the control blocks,
and wherein the control modules are connected in a multi-level manner.

3. The system according to claim 2, wherein the master controller is connected to the control modules by a first control bus.

4. The system according to claim 2, wherein the control modules connected in the multi-level are connected to each other by a second control bus.

5. The system according to claim 2, wherein the control module of the upper control block is connected to the bus arbiter by the second control bus, and the bust arbiter is connected to the master controller of the lower control block by the first control bus.

6. The system according to claim 2, wherein the master controller of the upper control block is connected to the bus arbiter by the first control bus, and the bus arbiter is connected to the remote control block by a network attaching control bus.

7. The system according to claim 2, wherein the control module comprises:
a condition monitoring unit,
a control parameter unit to store parameters, such as speed, location, acceleration,
a control loop unit,
a control driver unit,
an upper control interface unit, and
a lower control interface unit.

8. The system according to claim 1, wherein the bus arbiter comprises:
a scheduling unit,
a latency calculation unit,
a packet manipulation unit, and
a control packet queuing buffer unit.

9. The system according to claim 3, wherein the first control bus comprises:
global or designated target control module addresses,
control commands, and
control data or status signals,
wherein the first control bus is formed of a frame or packet.

10. The system according to claim 5, wherein the first control bus comprises:
global or designated target control module addresses,
control commands, and
control data or status signals,
wherein the first control bus is formed of a frame or packet.

11. The system according to claim 6, wherein the first control bus comprises:
global or designated target control module addresses,
control commands, and
control data or status signals,
wherein the first control bus is formed of a frame or packet.

12. The system according to claim 4, wherein the second control bus comprises:
designated target control module addresses,
control commands, and
control data or status signals,
wherein the first control bus is formed of a frame or packet.

13. The system according to claim 5, wherein the second control bus comprises:
designated target control module addresses,
control commands, and
control data or status signals,
wherein the first control bus is formed of a frame or packet.

14. The system according to claim 6, wherein the network attaching control bus uses the first or second control bus by summarizing or dissembling it as a packet.
